(19) United States
(12) Patent Application Publication
(10) Pub. No.: US 2015/0206386 A1
(43) Pub. Date: Jul. 23, 2015

(54) GAMING APPARATUS AND METHOD WITH THRESHOLD-BASED EVENT TRIGGER

(71) Applicant: WMS Gaming Inc., Waukegan, IL (US)

(72) Inventors: Joel R. Jaffe, Glenview, IL (US); Anthony Baerlocher, Henderson, NV (US); Matthew J. Ward, Northbrook, IL (US)

(21) Appl. No.: 14/158,631

(22) Filed: Jan. 17, 2014

(51) Int. Cl. G07F 17/32

(52) U.S. Cl. CPC G07F 17/3244; G07F 17/3262

(57) ABSTRACT

A gaming system and method include receiving a first input indicative of a first wager amount to play a wagering game. In response to a base monetary award for a determined outcome exceeding a predetermined non-zero threshold, a rounding event is triggered. An offer to gamble a monetary amount that is at least the difference between the base monetary award and the predetermined non-zero threshold is displayed. In response to receiving a second input indicative of an acceptance of the offer to gamble, play of a gamble feature of the rounding event is initiated. In response to achieving a winning outcome in the gamble feature, a final award is awarded that is greater than the base monetary award. In response to achieving a non-winning outcome in the gamble feature, a final award is awarded that is equal to the base monetary award minus the monetary amount of the offer to gamble.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to wagering games including a threshold-based event trigger.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system comprises one or more input devices, a display device, and game-logic circuitry. The game-logic circuitry comprises one or more central processing units and one or more memory devices. The one or more memory devices store instructions that, when executed by the one or more central processing units, cause the game-logic circuitry to receive, via at least one of the one or more input devices, a first input indicative of a first wager amount to play a wagering game. An outcome of the wagering game is determined. In response to a base monetary award for the outcome exceeding a predetermined non-zero threshold, a rounding event is triggered that provides an opportunity to increase the base monetary award. An offer to gamble a monetary amount that is at least the difference between the base monetary award and the predetermined non-zero threshold is displayed on the display device. A second input indicative of an acceptance of the offer to gamble is received via at least one of the one or more input devices. In response to receiving the second input, play of a gamble feature of the rounding event is initiated. An outcome of the gamble feature is determined. In response to achieving a winning outcome in the gamble feature, a final award is awarded that is greater than the base monetary award. In response to achieving a non-winning outcome in the gamble feature, a final award is awarded that is equal to the base monetary award minus the monetary amount of the offer to gamble such that the final award is less than or equal to the predetermined non-zero threshold.

According to another aspect of the present invention, a gaming system comprises one or more input devices, a display device, and game-logic circuitry. The game-logic circuitry comprises one or more central processing units and one or more memory devices. The one or more memory devices store instructions that, when executed by the one or more central processing units, cause the game-logic circuitry to receive, via at least one of the one or more input devices, a first input indicative of an initial wager to play a wagering game. An outcome of the wagering game is determined. In response to a base monetary award for the outcome being less than a predetermined non-zero threshold that is a function of the initial wager, a rounding event is triggered that provides an opportunity to increase the base monetary award. An offer to gamble the base monetary award is displayed on the display device. A second input indicative of an acceptance of the offer to gamble is received via at least one of the one or more input devices. In response to receiving the second input, play of a gamble feature of the rounding event is initiated. An outcome of the gamble feature is determined. In response to achieving a winning outcome in the gamble feature, a final award is awarded having an expected value that is greater than or equal to the predetermined non-zero threshold.

According to another aspect of the invention, a computer-implemented method in a gaming system has game-logic circuitry including one or more central processing units and one or more memory devices. The method comprises receiving, via one or more input devices, a first input indicative of a first wager amount to play a wagering game. An outcome of the wagering game is determined by the game-logic circuitry. In response to a base monetary award for the outcome exceeding a predetermined non-zero threshold, a rounding event is triggered by the game-logic circuitry that provides an opportunity to increase the base monetary award. An offer to gamble a monetary amount that is at least the difference between the base monetary award and the predetermined non-zero threshold is displayed on one or more display devices. A second input indicative of an acceptance of the offer to gamble is received via at least one of the one or more input devices. In response to receiving the second input, play of a gamble feature of the rounding event is initiated by the game-logic circuitry. An outcome of the gamble feature is determined by the game-logic circuitry. In response to achieving a winning outcome in the gamble feature, a final award is awarded by the game-logic circuitry that is greater than the base monetary award. In response to achieving a non-winning outcome in the gamble feature, a final award is awarded by the game-logic circuitry that is equal to the base monetary award minus the monetary amount of the offer to gamble such that the final award is less than or equal to the predetermined non-zero threshold.

According to yet another aspect of the invention, a computer-implemented method in a gaming system has game-logic circuitry including one or more central processing units and one or more memory devices. The method comprises receiving, via an input device, a first input indicative of an initial wager to play a wagering game. An offer to gamble in a rounding event base monetary awards for any outcomes less than a predetermined non-zero threshold that is a function of the initial wager is displayed on a display device. The rounding event provides an opportunity to increase the base monetary awards. A second input indicative of an acceptance of the offer to gamble in the rounding event is received via the input device. An outcome of the wagering game is determined by the game-logic circuitry. In response to a base monetary award for the outcome being less than the predetermined non-zero threshold, the rounding event is triggered by the game-logic circuitry. In response to receiving the second input, play of a gamble feature of the rounding event is initiated by the game-logic circuitry. An outcome of the gamble feature is determined by the game-logic circuitry. In response to achieving a winning outcome in the gamble feature, a final award having an expected value that is greater than or equal to the predetermined non-zero threshold is awarded by the game-logic circuitry.

According to yet another aspect of the invention, computer readable storage media is encoded with instructions for directing a gaming system to perform the above methods.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an aspect of the present invention.

FIG. 2 is a schematic view of a gaming system according to an aspect of the present invention.

FIG. 3 is an image of an exemplary basic-game screen of a wagering game displayed on a gaming terminal, according to an aspect of the present invention.

FIG. 4 is an image of an exemplary bonus-game screen of a wagering game displayed on a gaming terminal, according to an aspect of the present invention.

FIG. 5 is an image of an exemplary game screen of a wagering game displayed on a gaming terminal, according to an aspect of the present invention.

FIG. 6 is an image of an exemplary game screen of a wagering game with an offer to gamble displayed on a gaming terminal, according to an aspect of the present invention.

FIGS. 7A to 7C are images of an exemplary gamble feature for a rounding event, according to an aspect of the present invention.

FIGS. 8 and 9 are images of an exemplary game screen of a wagering game including a base award displayed on a gaming terminal, according to an aspect of the present invention.

FIG. 10 is an image of an exemplary game screen of a wagering game with an offer displayed on a gaming terminal, according to an aspect of the present invention.

FIG. 11 is an image of an exemplary game screen of a wagering game displayed on a gaming terminal with player-selectable elements for customizing a rounding event, according to an aspect of the present invention.

FIGS. 12A and 12B are images of an exemplary gamble feature for a rounding event, according to an aspect of the present invention.

FIGS. 13-15 are flowcharts for algorithms that correspond to instructions executed by one or more central processing units in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

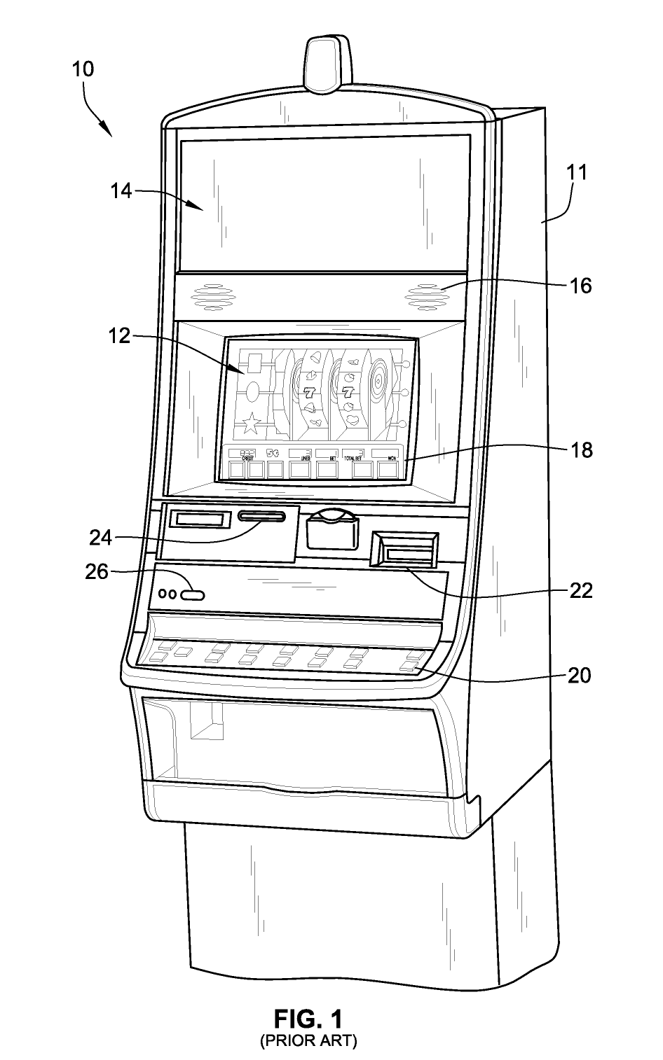

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433 and Patent Application Publication Nos. US2010/0069160 and US2010/0234099, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

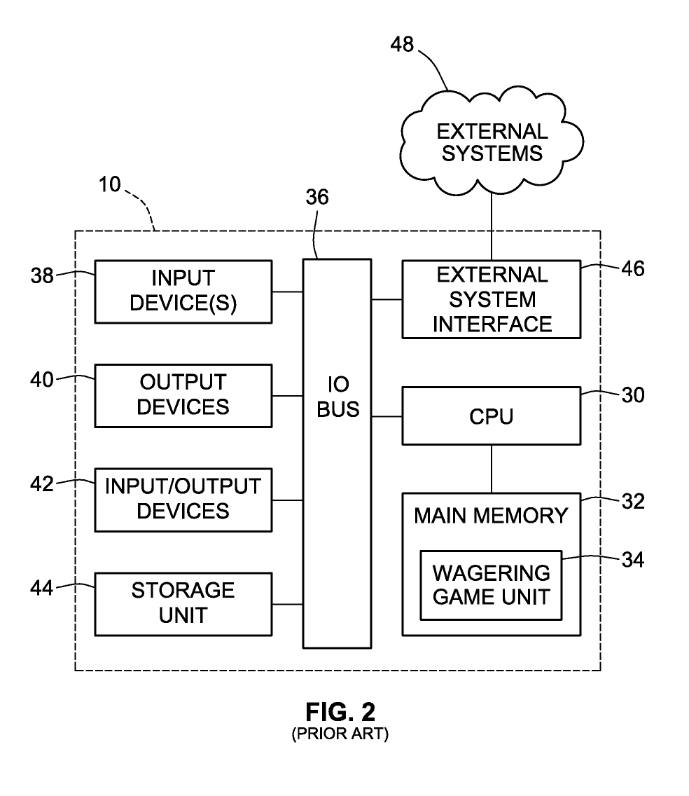

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

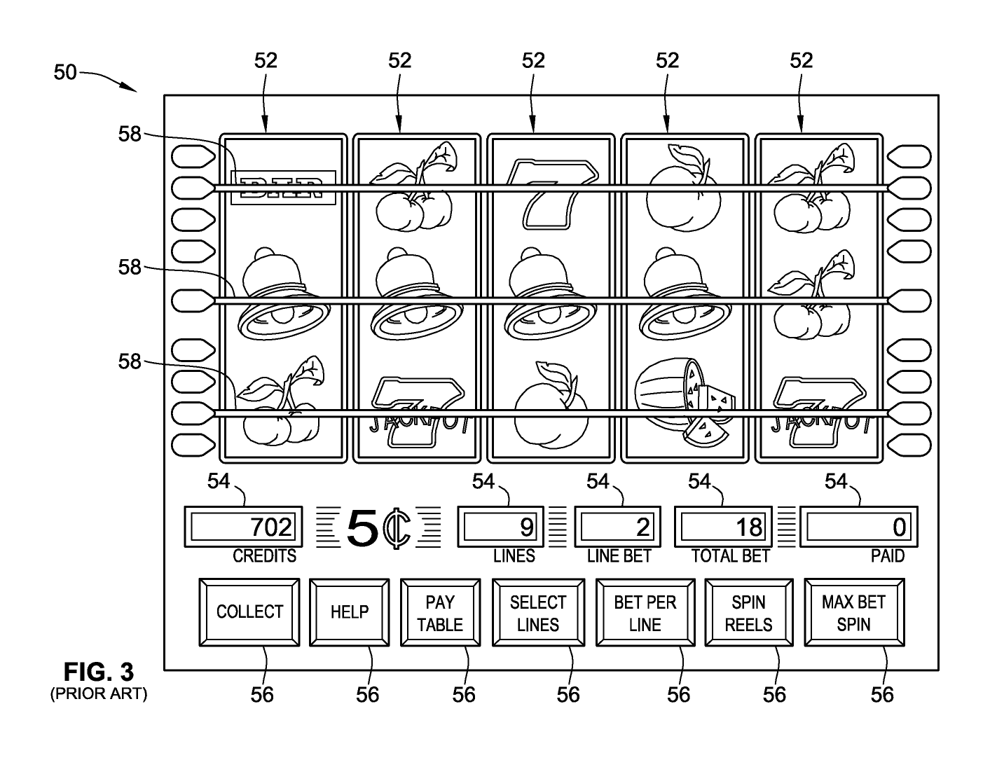

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The game-logic circuitry 28 operates to execute a wagering-game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

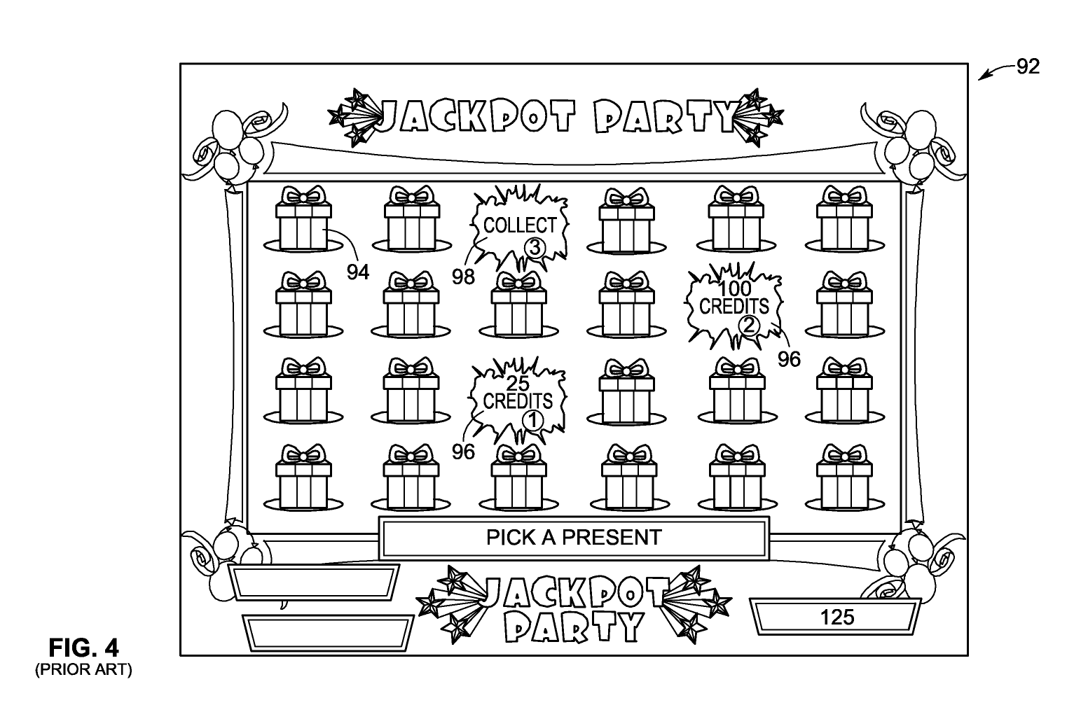

Turning now to FIG. 4, an example of a bonus game to a basic wagering game is illustrated. A bonus-game screen 92 includes an array of markers 94 located in a plurality of columns and rows. The bonus game is entered upon the occurrence of a triggering event, such as the occurrence of a start-bonus game outcome (e.g., symbol trigger, mystery trigger, time-based trigger, etc.) in or during the basic wagering game. Alternatively, any bonus game described herein is able to be deployed as a stand-alone wagering game independent of a basic wagering game.

In the illustrated bonus game of FIG. 4, a player selects, one at a time, from the array of markers 94 to reveal an associated bonus-game outcome. According to one embodiment of this bonus game, each marker 94 in the array is associated with an award outcome 96 (e.g., credits or other non-negative outcomes) or an end-game outcome 98. In the illustrated example, a player has selected an award outcome 96 with the player's first two selections (25 credits and 100 credits, respectively). When one or more end-game outcome 98 is selected (as illustrated by the player's third pick), the bonus game is terminated and the accumulated award outcomes 96 are provided to the player.

A desirable aspect for a wagering game can include an option for play of a rounding event that provides an opportunity for a player of the wagering game to increase a base award. The base award is received in response to achieving a winning outcome in the wagering game. In some aspects, the rounding event is implemented as a result of a base monetary award for a winning outcome equaling or exceeding a predetermined non-zero award threshold. In some aspects, the rounding event is implemented as a result of a base monetary award for a winning outcome being less than or equal to a predetermined non-zero threshold that is a function of the initial wager for the wagering game.

In some aspects, the wagering game triggers the option to play a rounding event when a base award for a winning outcome achieved in the wagering game exceeds a certain pre-determined non-zero threshold, such as a government-determined threshold (e.g., a win amount that requires certain actions by a casino; a win amount that if awarded temporarily suspends play at the gaming terminal) or a player-determined threshold. The rounding event provides the player the option to wager, at least the difference between the predetermined non-zero threshold and the win amount from the base award, in a gamble feature. If a winning outcome is achieved in the gamble feature, a final award for the wagering game is awarded that is greater than the base award. If a non-winning outcome is achieved in the gamble feature, a final award that is less than or equal to the predetermined non-zero threshold is awarded.

In one exemplary aspect, a predetermined non-zero threshold may be set at an award of 1200 credits or more. If a base award in response to a winning outcome in the wagering game is 1499 credits, the player is then given the option to play a gamble feature of a rounding event. The rounding event includes an offer to gamble a monetary amount of 300 credits. If the player accepts the offer and loses the gamble feature, the final award will be the difference between the base award and the monetary amount of the offer to gamble, or 1199 credits (e.g., 1499 credits minus 300 credits). For predetermined non-zero thresholds that are government-determined threshold(s), such as in the examples provided above, no further action would be required by the casino (e.g., no suspension of play would be needed for the gaming terminal hosting the wagering game) because the final award that is actually awarded to the player now falls below the predetermined non-zero threshold. If a winning outcome is achieved for the gamble feature, a final award that is greater than the base award (e.g., 1499 credits) is credited. In some aspects, the increase to the final award may be based on the true odds of the gamble feature. For example, if the odds of achieving a winning outcome in the gamble feature of the rounding event is 5-to-1 and with a 300 credit gamble amount, a winning outcome in the gamble feature will result in a final award of 2,999 credits (e.g., 1499 credits for the base award plus 300 credits times five) being awarded to the player.

Where a predetermined non-zero threshold amount may be determined by certain regulatory requirements, the rounding event aspects described in the present disclosure can be desirable because the event minimizes the frequency final awards or crediting to a player of amounts exceeding the threshold amount. This can be particularly desirable where the regulatory-driven threshold (e.g., an award amount that triggers reporting events for tax purposes) may temporarily suspend or lock up a gaming terminal, require certain actions by the casino or player before the gaming terminal can be allowed to continue wagering game play, or otherwise detract from the player's gaming experience.

In the example where a player loses the gamble feature, the final award is reduced below the predetermined threshold, which is an outcome the player may consider desirable despite the gamble feature loss because the player will be allowed to continue play without interruption and receive a majority of the base award win amount. If the player wins the gamble feature, the player can be provided with a substantial increase with the crediting of the final award, which the player, too, may view as favorable compensation despite play at the gaming terminal being temporarily suspended or requiring action from the casino before play can continue.

In some aspects, it is contemplated that the win amount from the base award is not awarded or credited to the player until after a response to the option to play the rounding event is received (e.g., the player declining the option to play the rounding event or until after the rounding event is completed and a final award is determined for the wagering game as a result of the player either winning or losing the gamble feature). Thus, the achievement of the base award and an increase (or decrease) to the base monetary award that result in the final award are all associated with a single wagering event. So, despite a monetary amount associated with the offer to gamble being received where the player accepts the offer to gamble in the rounding event, the monetary amount associated with the offer to gamble is a portion of the winning amount in the base award played prior to the rounding event, and therefore, part of the wagering event associated with the player's initial wager to player the wagering game.

In some aspects, the predetermined non-zero threshold for triggering a rounding event is achieving a winning outcome having an award equal to the initial wager that was received for the wagering game. The player can similarly can be given the option to play a gamble feature of the rounding event that includes a gamble amount equal to (or less than) the base monetary award (e.g., which may equal the initial wager). If the player loses the gamble feature, the final award will be the difference between the initial wager and the gamble amount associated with an offer to gamble in the rounding event. In instances where the entire base award was gambled in the rounding event, the final award will be zero. If the player wins the gamble feature, the final award can be increased so that the final award being awarded is greater than the base monetary award. In some aspects, the increase or payout based on the gamble amount associated with the offer to gamble in the rounding event is based on the true odds of the gamble feature.

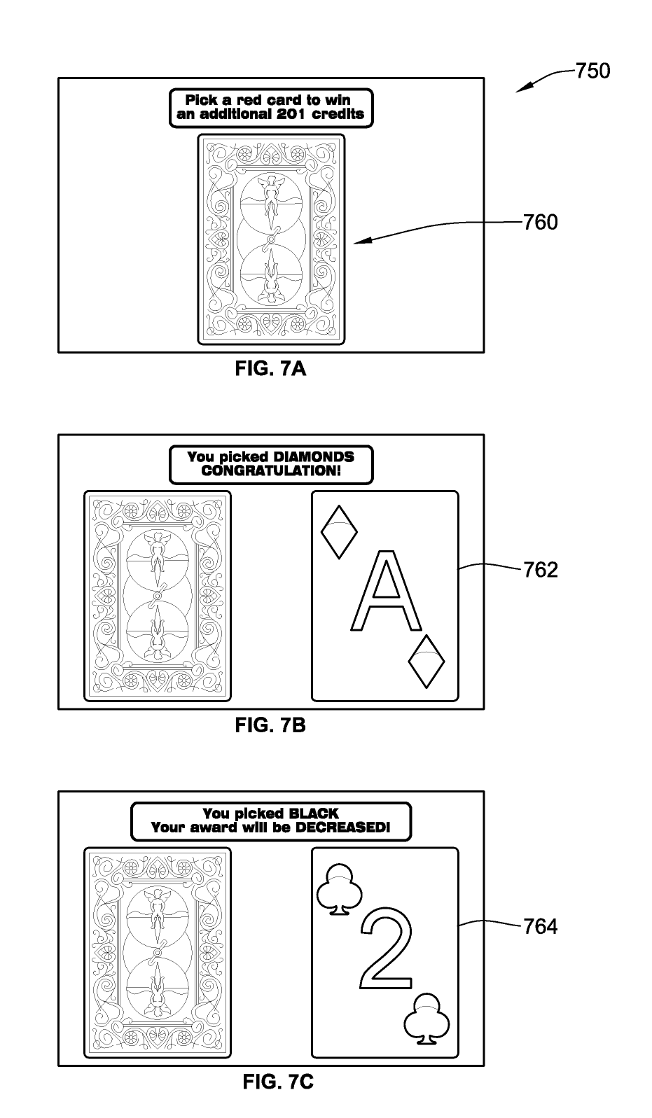

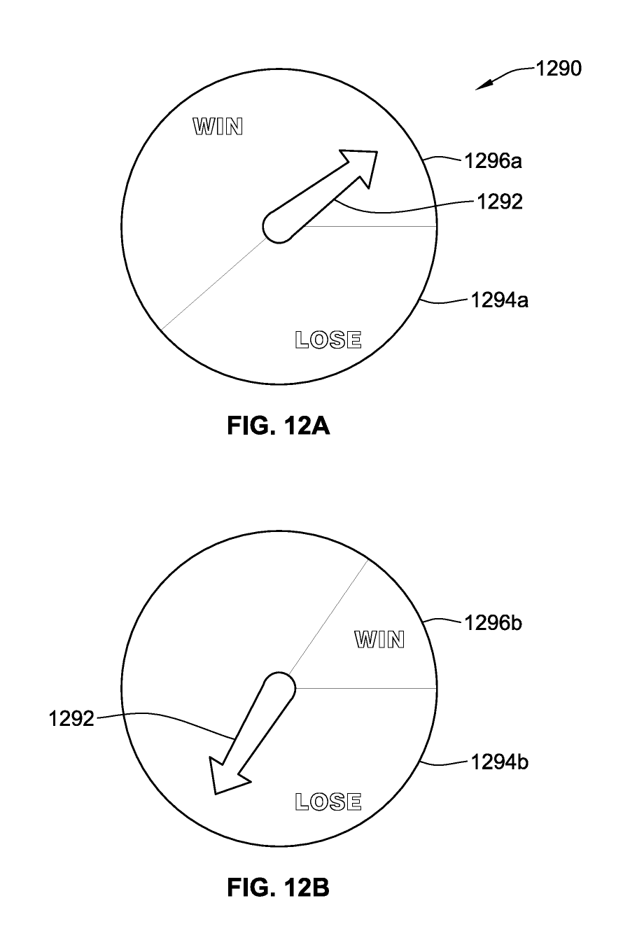

The gamble feature aspects of the described rounding event can include different types of gambles. For example, the gamble feature can be based on a spin of a wheel, a spin of a pointer (see, e.g., FIGS. 12A-12B), a spin of one or more reels of a slots game, a dice roll, a card game (see, e.g., FIGS. 7A-7C), a picking game, or other similar games including games with fixed odds or odds that can be easily calculated or understood by a player. It is contemplated that in some aspects the gamble feature portrays concept(s) of true odds to the player. In some aspects, the gamble feature applies actual true odds to determine the gamble feature outcome.

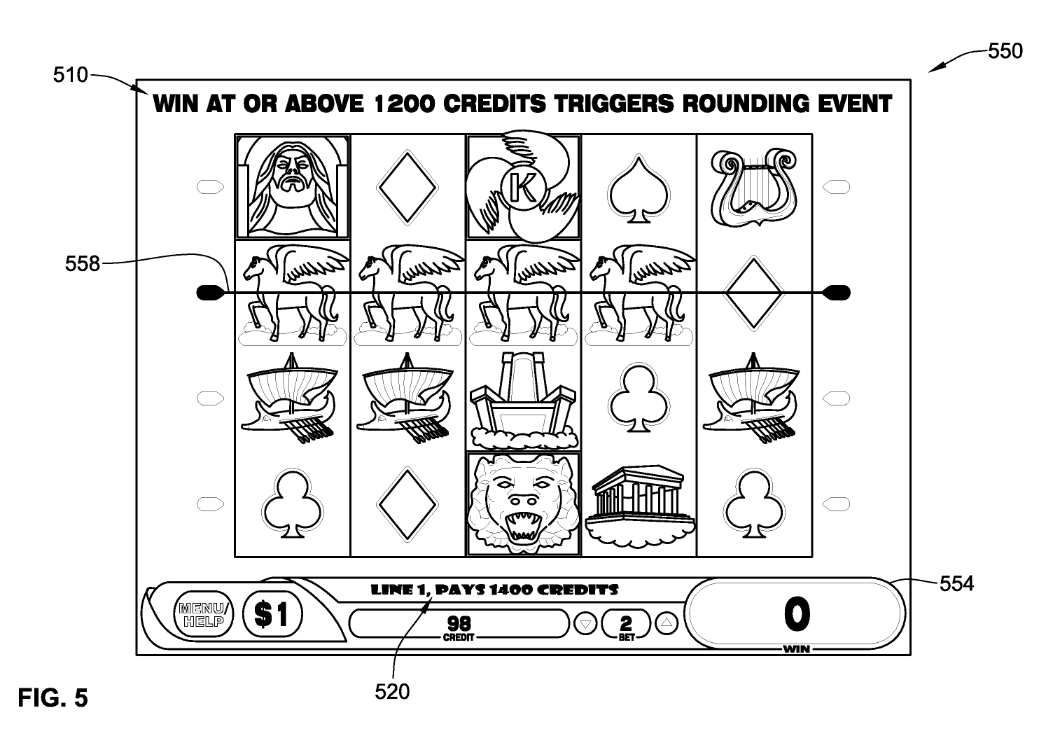

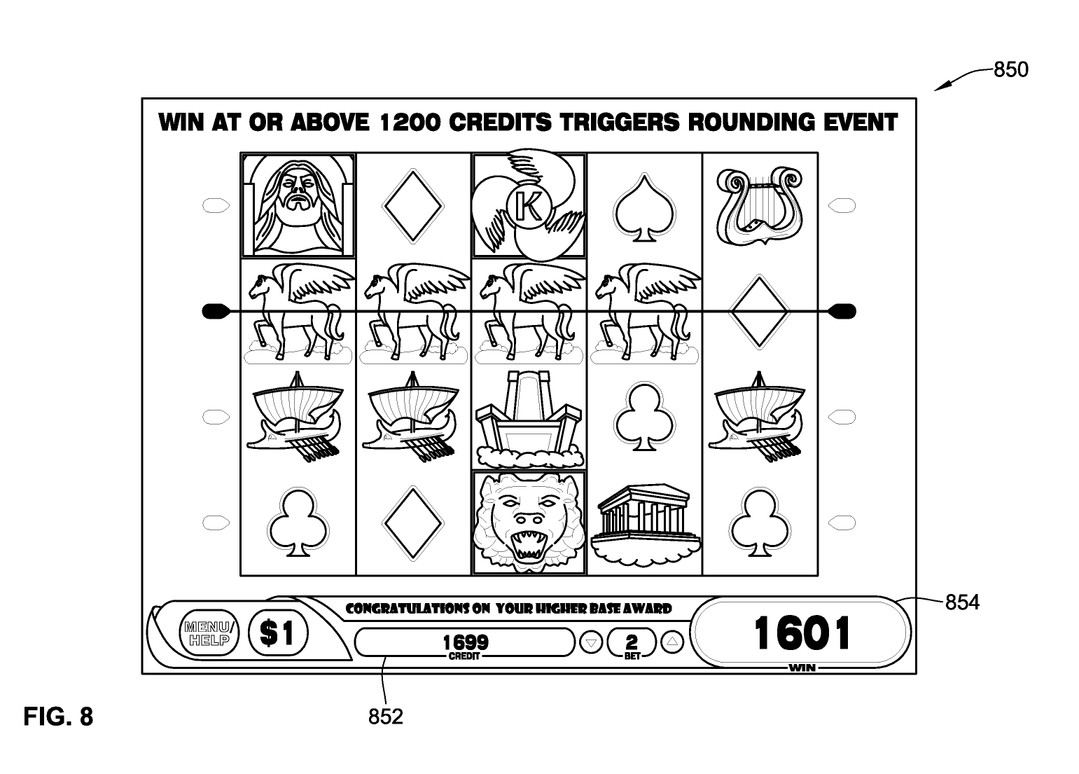

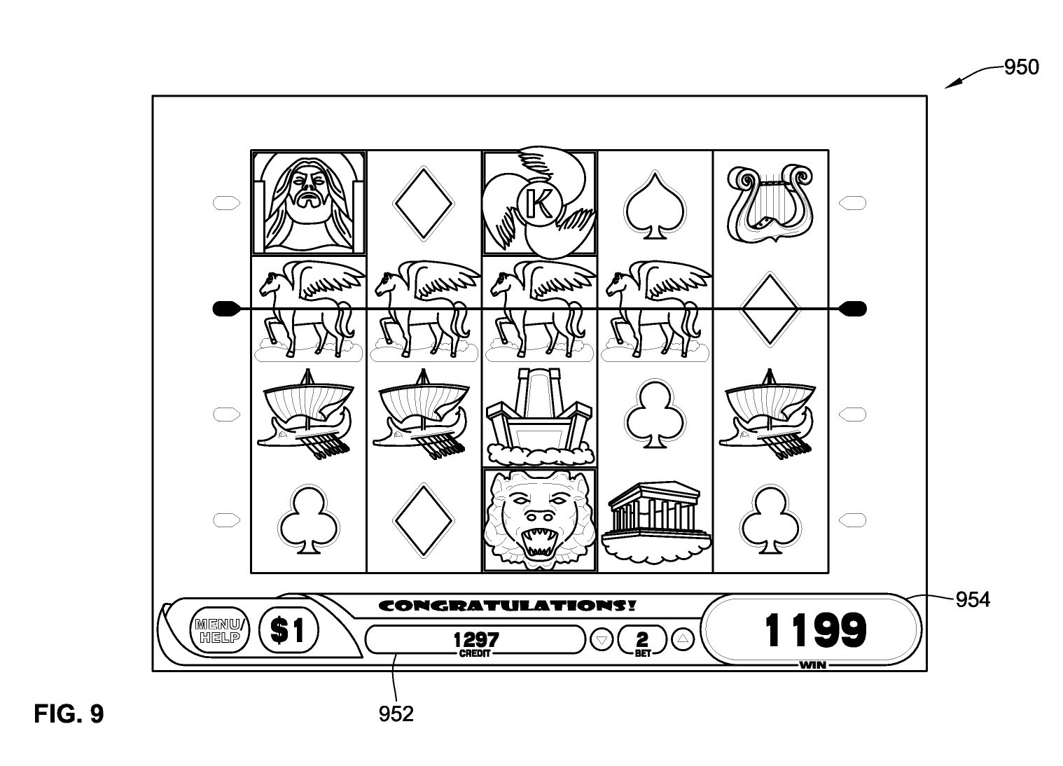

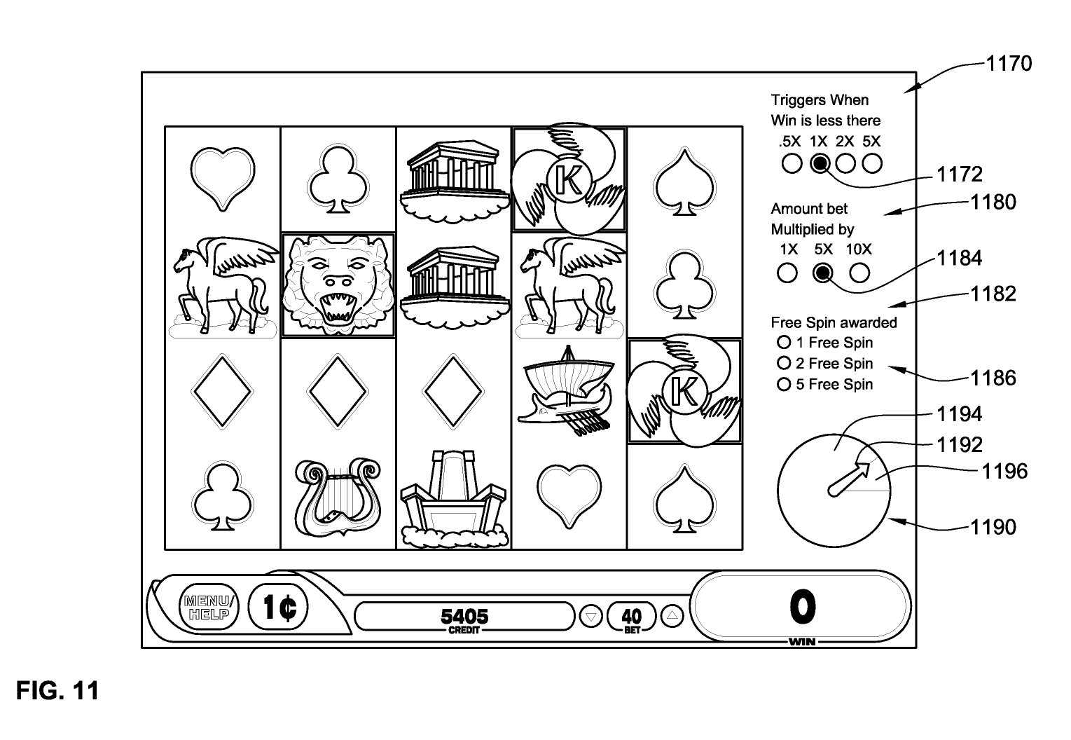

Turning now to FIG. 5, an exemplary game screen 550 of a wagering game is displayed on a gaming terminal, such as the gaming devices described in FIGS. 1 and 2. For the illustrated wagering game, a predetermined non-zero threshold has been established above which a rounding event is triggered (see, e.g., element 510). The threshold for this particular example is win amounts above 1200 credits. However, in some aspects, the threshold for triggering the rounding event can be any predetermined non-zero amount, and include thresholds set by government regulations. It is also contemplated that the pre-determined non-zero threshold can be defined according to various player-selectable threshold options that the player can select before or as an initial step of play of the wagering game (see, e.g., FIG. 11). The player in this exemplary wagering game has achieved a winning outcome along a payline 558 (e.g., the four flying horses on adjacent reels of a slots game). The exemplary base monetary award associated with this winning outcome is 1400 credits (see, e.g., element 520) and is based on an exemplary initial wager of 2 credits. As illustrated by win meter 554, despite the winning outcome, the base monetary award remains at zero because the base monetary award for the outcome exceeds the predetermined non-zero threshold (e.g., the win amount of 1400 credits exceeds the 1200 credit threshold), and has triggered a rounding event that is discussed in more detail in FIGS. 5-9, where after the completion of the rounding event, a final award is determined and displayed in the win meter (see, e.g., FIGS. 8 and 9).

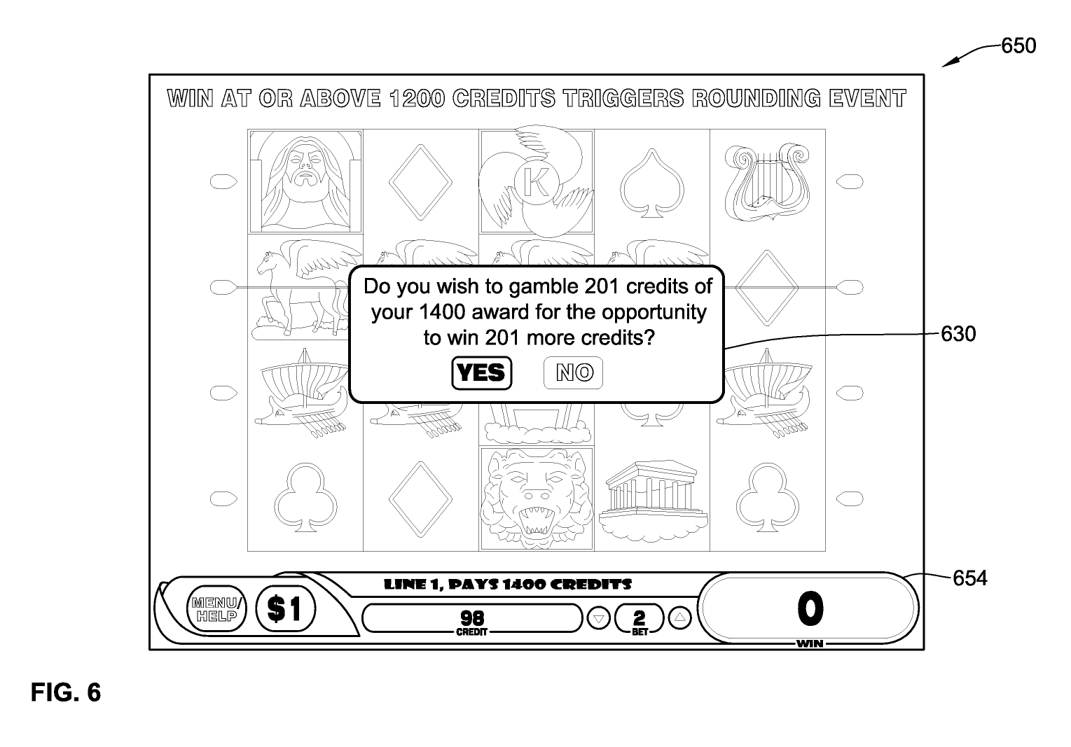

Turning now to FIG. 6, an exemplary game screen 650 of a wagering game, such as the wagering game described for FIG. 5, is illustrated. As part of the triggered rounding event described above for FIG. 5, an offer to gamble 630 a monetary amount is displayed on the screen 650. The offer is for the difference (e.g., 201 credits) between a base award (e.g., 1400 credits for Line 1 from FIG. 5) and the predetermined non-zero threshold (e.g., winning amounts above 1200 credits that triggers the rounding event). In some aspects, a player is given the option to make a selection for accepting or rejecting the offer. If an input is received rejecting the offer, the win meter 654 will indicate the final award credited to the player based on the base award from the winning outcome of the wagering game. In response to receiving an input indicative of an acceptance (e.g., selecting “YES”) of the offer to gamble, play of a gamble feature associated with the rounding event is initiated.

Turning now to FIGS. 7A to 7C, images of an exemplary game screens 750 of a gamble feature for a rounding event are illustrated. The gamble feature illustrates in FIG. 7A-7C is a simple card picking game where a player picks the top card from a deck of cards 760. In this particular example, a pick of a winning red card 762 (e.g., the ace of diamonds) results in the achievement of a winning outcome for the gamble feature and a simple true odds payout (e.g., a gamble amount of 201 credits having a 201 credit payout) based on a deck having the same number of red and black cards. The final award is then subsequently determined for the winning outcome as illustrated in the exemplary game screen in FIG. 8. However, a pick of a losing card 764 (e.g., two of clubs) results in the achievement of a non-winning outcome for the gamble feature and the final award being less than the predetermined non-zero threshold (e.g., win above 1200 credits) and a decrease to the base award from the outcome of the wagering game, as illustrated in the exemplary game screen in FIG. 9. It is contemplated that the payout amount can be increased while still maintaining a true odds payout where the gamble feature includes more or fewer winning elements in a finite pool of elements (e.g., more red cards in the deck). As discussed below, a player may be given the option to customize the desired payout for the gamble feature with the understanding that the odds of achieving a higher payout will be lower than, for example, the straight “double-up” type payout that is illustrated.

FIGS. 8 and 9 illustrate exemplary game screens 850, 950 of a wagering game, such as the wagering games described above in FIGS. 5-7. FIG. 8 illustrates the awarding of a final award for a wagering game in response to a winning outcome for the gamble feature, such as the winning outcome illustrated in FIG. 7B. As discussed previously for FIG. 5, the base monetary award is not awarded until after the offer to gamble is declined or after the outcome of the gamble feature of the rounding event is determined. After the player wins the gamble feature, the final award is determined and includes the base award (e.g., 1400 credits) plus the award resulting from a winning outcome in the gamble feature (e.g., an additional 201 credits). Thus, in the exemplary aspect illustrated in FIG. 8, the win meter 854 indicates the final award (e.g., 1601 credits), which is added to the player's total credits (e.g., 98 credits plus the final award of 1601 credits) indicated by credit meter 852.

If the player loses or has a non-winning outcome for the gamble feature, a final award is also awarded to the player that is equal to the base award (e.g., 1400 credits) minus the amount of the offer to gamble (e.g., 201 credits from FIG. 6). For a non-winning outcome of the gamble feature, the final award will be less than, or less than or equal to, the predetermined non-zero threshold. In the exemplary aspect illustrated in FIG. 9, the win meter 954 indicates the final award (e.g., 1199 credits), which is added to the player's total credits (e.g., 98 credits plus the final award of 1199 credits) indicated by credit meter 952.

Additional aspects of the features described for FIGS. 5 to 9 are contemplated. For example, the odds payout for the gamble feature can be adjusted to provide true odds or the appearance of true odds such that the payout for the final award is at least 25 percent greater than the base monetary award (e.g., at least enough to cover any implications of a taxable event) for a winning outcome for the gamble feature. As discussed previously, the predetermined non-zero threshold may be based on a government-determined threshold amount. In some aspects, government-determined threshold amount is a base award amount that, when exceeded, requires further play of the wagering game to be temporarily suspended. In some aspects, the rounding event includes an option for a non-random player selection of the increase to the base monetary award (e.g., a multiple of the base monetary award) that is received for a winning outcome in the gamble feature. In other aspects, the predetermined non-zero threshold is defined according to non-random player-selectable threshold options. These player-selectable options can be selected either before or after the trigger of the rounding event. In some instances, the rounding event is automatically initiated based on the player selections made before any triggering event occurs.

Further aspects of the wagering games described in FIGS. 5 to 9 include the opportunity to place an additional wager in the middle of the play of the wager game, but where the additional wager is consider part of the initial wager. For example, a winning outcome may exceed a predetermined non-zero threshold that results in a taxable event for the player that requires reporting once the winning amount is awarded. The player can then be provided an offer to gamble the difference between the winning amount of the base monetary award and the predetermined threshold. However, if the payout for a winning outcome in a gamble feature based on the offer to gamble would be insufficient to cover the taxable amount, the player can be given a further option to gamble an additional amount. In another aspect, the player can be given the option to select a payout with lower odds of achieving a winning outcome but with a sufficient payout to cover any type of taxable event or payout that is desired by the player. In some aspects, a player-selectable element may be presented to the player before play of the wagering game or as part of the rounding event giving the player the option of an increased payout in exchange for lower odds of winning the gamble feature.

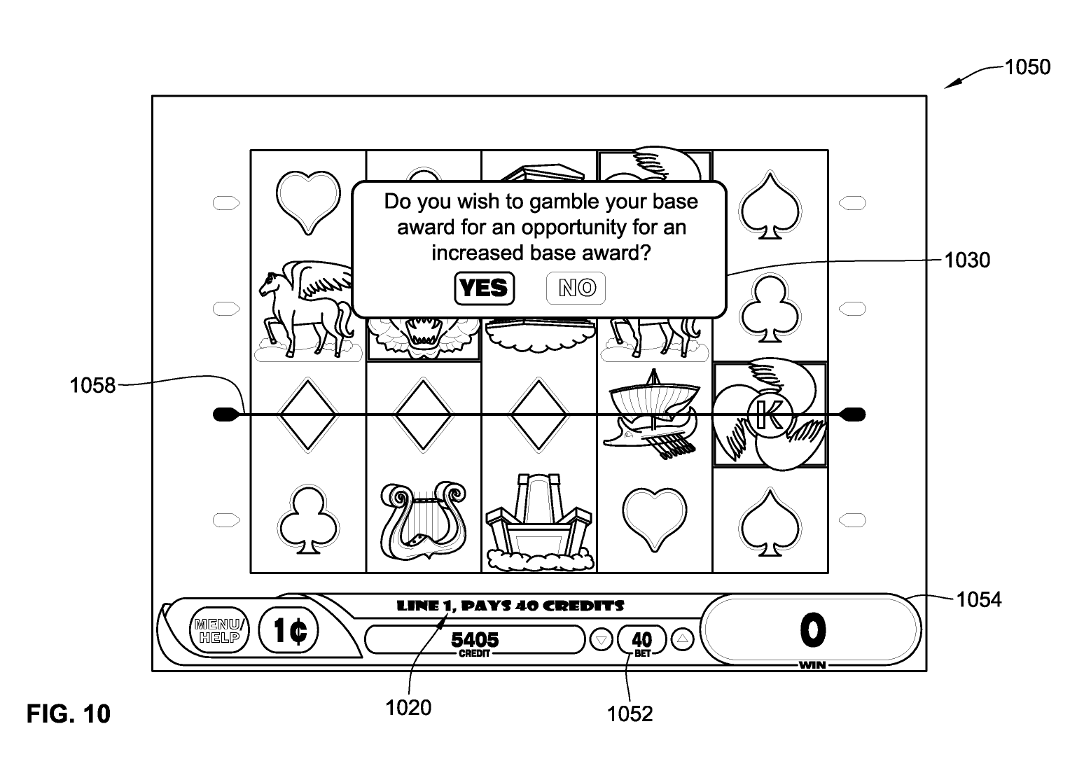

Turning now to FIG. 10, an exemplary game screen 1050 of a wagering game is displayed on a gaming terminal, such as the gaming devices described in FIGS. 1 and 2. For the illustrated wagering game, a predetermined non-zero threshold has been established that is a function of the initial wager. For example, the wager indicated in the wager meter 1052 indicates an exemplary initial wager of 40 credits. The threshold for triggering a rounding event in this example can be any base monetary award for an outcome of the wagering game being less than, or less than or equal to, a predetermined non-zero amount that is a function (e.g., 0.5×, 1×, 2×, 5×) of the initial wager. It is also contemplated that the pre-determined non-zero threshold can be defined according to various player-selectable threshold options that the player can select before or as an initial step of play of the wagering game. The predetermined non-zero threshold for the exemplary aspect illustrated in FIG. 10 is one times (1×) the initial wager (e.g., 40 credits). The player in this exemplary aspect of a wagering game has achieved a winning outcome along a payline 1058 that includes three diamonds. The base monetary award associated with this winning outcome is 40 credits (see, e.g., element 1020) and is based on the initial wager of 40 credits. As illustrated by win meter 1054, despite the winning outcome, the base monetary award remains at zero because the base monetary award is less than, or less than or equal to, the predetermined non-zero threshold (e.g., the win amount of 40 credits equals the 40 credit threshold that is a 1× function of the initial wager), which triggers play of a rounding event after the completion of which a final award is determined and displayed in the win meter 1054.

As part of the triggered rounding event, an offer to gamble 1030 a monetary amount is displayed. The offer to gamble in the exemplary aspect of FIG. 10 is an offer to gamble the entire base monetary award (e.g., 40 credits) for an opportunity to increase the base monetary award. As part of the offer, the player is given the option to accept or reject the offer. If an input is received rejecting the offer, the win meter 1054 will indicate the final award given to the player for the winning outcome. In response to receive an input indicative of an acceptance (e.g., selecting “YES”) of the offer to gamble, play of a gamble feature associated with the rounding event is initiated. It is contemplated that in some aspects, the wagering game automatically implements the rounding event in response to an earlier input indicating an automatic acceptance of the rounding event for award outcome(s) that are equal to or that fall below the predetermined non-zero threshold. For example, the automatic triggering of the rounding event can occur in response to an offer to gamble the base monetary award and the acceptance thereof occurring before the outcome of the wagering game is determined. Plays of a gamble feature similar to that illustrated in FIGS. 7A-7C or as discussed otherwise in the present disclosure is then initiated and an outcome of the gamble feature is determined. In response to a winning outcome being achieved in the gamble feature, a final award is awarded that has an expected value that is greater than or equal to the predetermined non-zero threshold (e.g., an award that is greater than the base award that was equal to the initial wager).

Additional aspects of the features described for FIG. 10 are contemplated. For example, the final award can be a credit amount that results from play of a gamble feature of the rounding event, such as the card game, dice roll, picking game, or other events described herein. The final award can also be the result of a game play feature that has an opportunity for achieving winning outcome(s). For example, the gamble feature of the rounding event can be one or more free spin opportunities with the final award being based on the outcome(s) of the free spins. The free spins can have an expected value that is greater than or equal to the predetermined non-zero threshold. It is also contemplated that the gamble feature can use true odds to determine the outcome of the gamble feature. Furthermore, in some aspects, the rounding event can include an option for a non-random player selection of the final award to be received for achieving a winning outcome in the gamble feature, such as the selection of a whole-number multiple that is applied to the base monetary award to determine the final award. This feature may or may not be paired with another option for a non-random player selection of the predetermined non-zero threshold that triggers the rounding event. It is also contemplated that the predetermined non-zero threshold may be less than the base monetary award.

Turning now to FIG. 11, an image of an exemplary game screen of a wagering game displayed on a gaming terminal includes player-selectable features 1170, 1180, 1186 for customizing a rounding event. For example, player-selectable feature 1170 allows a player to select the predetermined non-zero threshold for triggering the rounding event based on different multiples (e.g., 0.5×, 1×, 2×, 5×) of the initial or first wager. It is also contemplated that in some aspects all winning outcomes in the wagering game can trigger the rounding event. Another player-selectable feature 1180 allows a player to customize the final award amount by selecting a multiplier 1182 (e.g., 1×, 5×, 10×) that a bet is to be multiplied by to determine the award for a winning outcome in the gamble feature. In another aspect, a player-selectable feature 1186 allows a player to customize that the final award is determined based on a number of free spins being awarded and then played to determine individual winning outcomes for each spin that are totaled to determine a cumulative winning outcome for the gamble feature.

It is contemplated that the gamble feature can then be a pointer 1192 on a wheel 1190 that is spun. Following a spin of the pointer 1192, the pointer 1192 can then point to either a winning region of the wheel 1196 or a losing region 1194 that are the basis for determining the outcome of the gamble feature.

Turning now to FIGS. 12A and 12B, images of an exemplary gamble feature for a rounding event are illustrated. Similar to the spinning pointer 1190 described for FIG. 11, some aspects of the gamble feature can includes a pointer 1292 that is spun when play of the gamble feature is initiated. The outcome of the gamble feature is then determined by where the pointer comes to a stop (e.g., in losing region 1294a, 1294b or the winning region 1296a, 1296b). The win and lose regions 1294, 1296 can be increased and decreased in size according to some of the player-selectable selections made. For example, the greater the payout or the number of free spins that are selected to be awarded in response to a winning outcome of the gamble feature, the lower the odds will be winning the gamble feature. If a player selects that the final award for a winning outcome of the gamble feature is an amount bet multiplied by five (see, e.g., element 1184 in FIG. 11), the payout is larger but the chances of winning the gamble feature are less than if an amount bet is multiplied by, for example, one. Thus, the chance of winning a selected 5× payout for the gamble might resemble a spinning pointer wheel similar to FIG. 12B and win region 1296b compared to the chance of winning a selected 1× payout for the gamble feature might resemble a spinning pointer wheel similar to FIG. 12A and win region 1296a. In another example in the context of a card game, such as the card game illustrated in FIG. 7, as the payout for a gamble feature is increased by certain player-selections (e.g., from 1× to 5×; from 1× to 10×, from 2× to 4×), the odds of achieving a winning outcome for the gamble feature can also be balanced by including more a less of winning or losing card (e.g., more red cards than black).

The aspects illustrated in FIGS. 11 and 12 can be desirable if a player wants the opportunity to win back a higher final award when a rounding event is triggered or have the opportunity to win free spins that can be spun for the chance to win a higher final award. For example, rather than the predetermined non-zero threshold being a function of 1× the initial wager and a 1× payout, the amount of the payout can be adjusted based on the player selection to a function of 5× the initial wager or to giving out a number of free spins. However, the winning region will decrease in size by 5 times. So, rather than the winning region being 50 percent of the pie chart or spinning pointer wheel 1290, it will decrease to being only 10 percent of the pie chart. Once the selections are made for the triggers and the payout, implementation of the rounding event occurs automatically during play of the wagering game. Part of the automated process can also include the base monetary award for the outcome being automatically used as the wager.

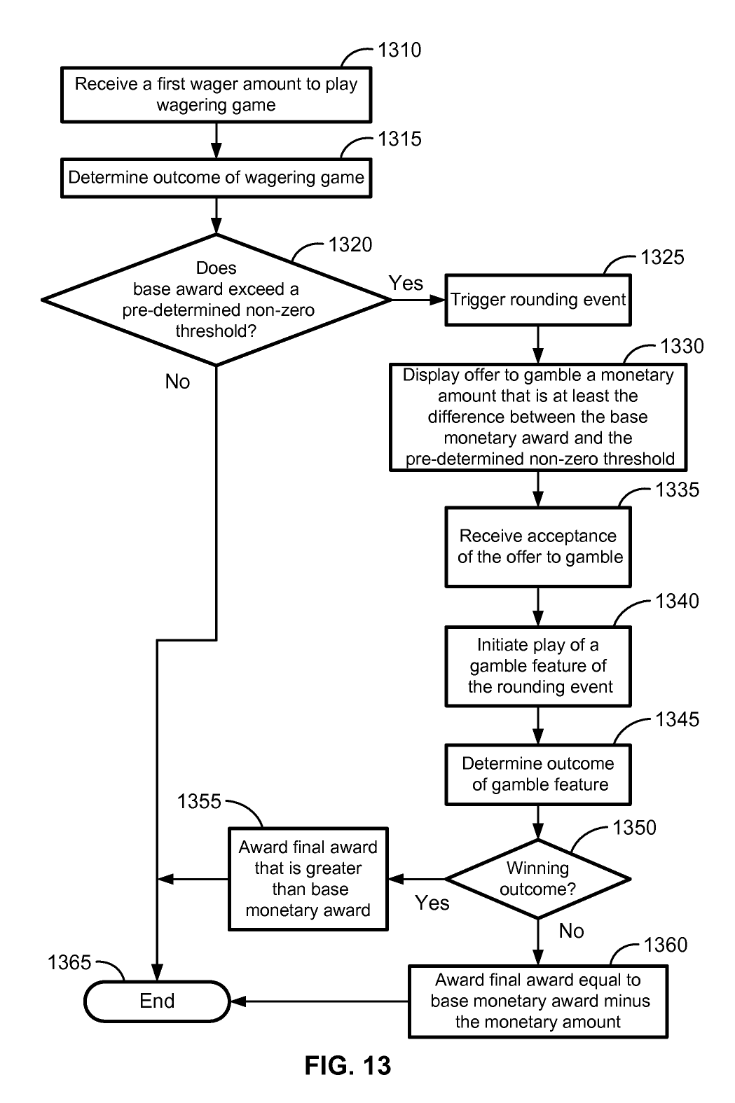

Turning now to FIG. 13, a flow chart is illustrated for an algorithm that corresponds to instructions executed by one or more central processing units in accord with at least some aspects of the disclosed concepts. The algorithm is part of a computer-implemented method in a gaming system having game-logic circuitry including the one or more central processing units and the one or more memory devices. At step 1310, a first input indicative of a first wager amount to play a wagering game is received via one or more input devices, such as the input devices described for FIGS. 1 and 2. Next, at step 1315, an outcome of the wagering game is determined by the game-logic circuitry. Then, at step 1320, if the outcome does not have a base award that exceeds a predetermined non-zero threshold, the method proceeds to step 1365 and ends. However, if a base monetary award for the outcome exceeds a predetermined non-zero threshold, the method proceeds to step 1325 where a rounding event that provides an opportunity to increase the base monetary award is triggered by the game-logic circuitry.

Next, at step 1330, an offer to gamble a monetary amount that is at least the difference between the base monetary award and the predetermined non-zero threshold is displayed on one or more display devices, such as the display devices described for FIGS. 1 and 2. Then, at step 1335, a second input indicative of an acceptance of the offer to gamble is received via at least one of the one or more input devices. Then, at step 1340, play of a gamble feature of the rounding event is initiated in response to receiving the second input. Next, at step 1345, an outcome of the gamble feature is determined by the game-logic circuitry. Then, at step 1350, if a winning outcome is achieved in the gamble feature, the process proceeds to step 1355 where a final award that is greater than the base monetary award is awarded. However, if at step 1350 a non-winning outcome is achieved in the gamble feature, the method proceeds to step 1360 where a final award equal to the base monetary award minus the monetary amount of the offer to gamble is awarded by the game-logic circuitry such that the final award is less than or equal to the predetermined non-zero threshold.

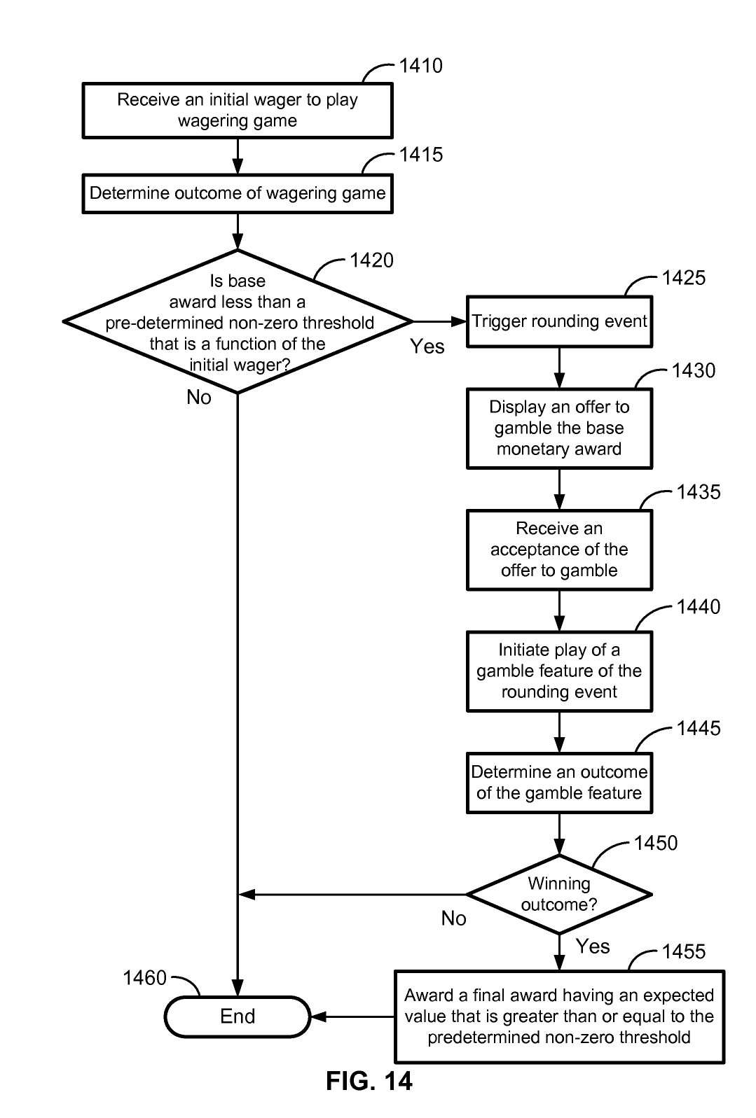

Turning now to FIG. 14, a flow chart is illustrated for an algorithm that corresponds to instructions executed by one or more central processing units in accord with at least some aspects of the disclosed concepts. The algorithm is part of a computer-implemented method in a gaming system having game-logic circuitry including the one or more central processing units and the one or more memory devices. At step 1410, a first input indicative of an initial wager to play a wagering game is received via one or more input devices, such as the input devices described for FIGS. 1 and 2. Next, at step 1415, an outcome of the wagering game is determined by the game-logic circuitry. Then, at step 1420, if the outcome does not have a base monetary award less than a pre-determined non-zero threshold that is a function of the initial wager, then the method proceeds to step 1460 where the method ends. However, if the outcome is a winning outcome with a base monetary award that is less than the pre-determined non-zero threshold, the method proceeds to step 1425 where a rounding event is triggered by the game-logic circuitry. The rounding event provides an opportunity to increase the base monetary award.

Next, at step 1430, an offer to gamble the base monetary award is displayed on one or more display devices, such as the display devices described for FIGS. 1 and 2. Then, at step 1435, a second input indicative of an acceptance of the offer to gamble is received via at least one of the one or more input devices. Next, at step 1440, in response to receiving the second input, play of a gamble feature of the rounding event is initiated. Then, an outcome of the gamble feature is determined at step 1445 by the game-logic circuitry. Next, at step 1450, if a winning outcome is not achieved, the method proceeds to step 1460 and ends. If at step 1450, a winning outcome is achieved, the method proceeds to step 1455, where in response to achieving the winning outcome in the gamble feature, a final award having an expected value that is greater than or equal to the predetermined non-zero threshold is awarded by the game logic circuitry.

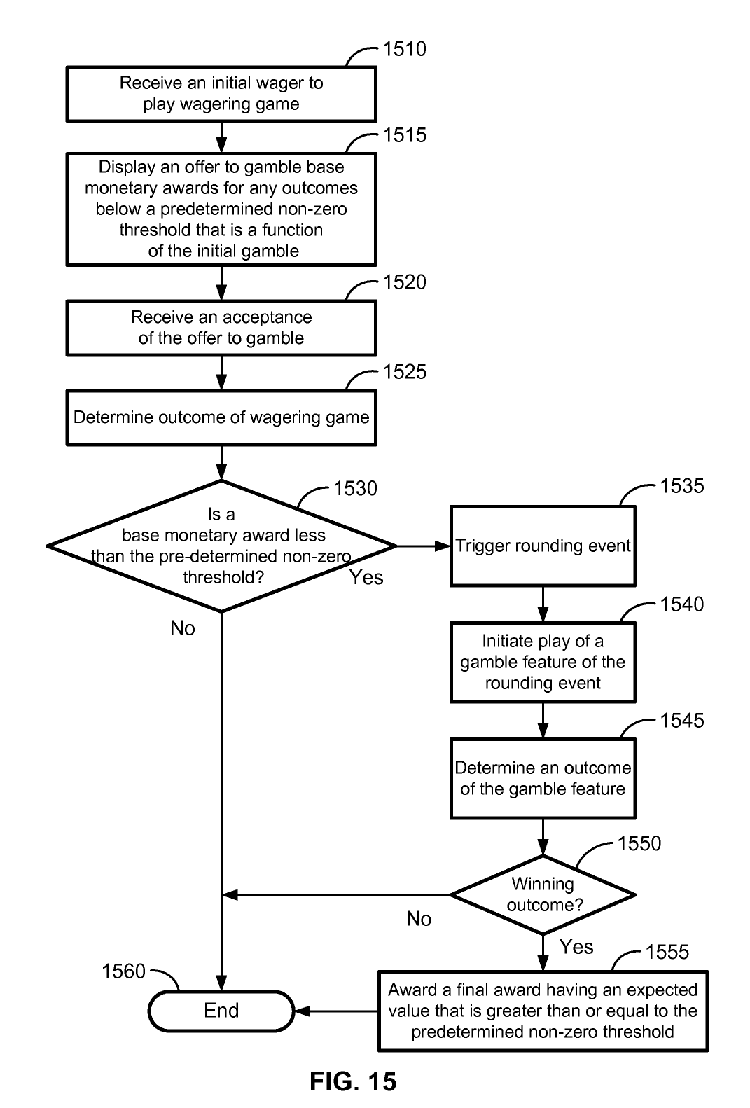

Turning now to FIG. 15, a flow chart is illustrated for an algorithm that corresponds to instructions executed by one or more central processing units in accord with at least some aspects of the disclosed concepts. The algorithm is part of a computer-implemented method in a gaming system having game-logic circuitry including the one or more central processing units and the one or more memory devices. At step 1510, a first input indicative of an initial wager to play a wagering game is received via an input device, such as the input devices described for FIGS. 1 and 2. Next, at step 1515, an offer to gamble in a rounding event is displayed on a display device. The rounding event is an event that provides an opportunity to increase a base monetary award. The offer to gamble is an offer to gamble the base monetary awards for any outcomes that are less than a predetermined non-zero threshold that is a function of the initial wager. For example, the pre-determined non-zero threshold could be equal to the wager or a multiple of the wager, such as 0.5×, 2×, 5×. The offer to gamble can also be in the form of player selectable elements that are displayed on a display device (e.g., see FIGS. 1 and 2) that allow a player to select from one or more options of a pre-determined non-zero threshold to be applied to the wagering game. At step 1520, a second input indicative of an acceptance of the offer to gamble in the rounding event is received. This second input can be received as part of a player selection of the player selectable elements displayed on the display device.

At step 1525, an outcome of the wagering game is determined by the game-logic circuitry. Next, at step 1530, if the outcome is a winning outcome with a base monetary award that is less than the pre-determined non-zero threshold, a rounding event is triggered by the game-logic circuitry. If the outcome does not have a base monetary award less than the pre-determined non-zero threshold, then the method proceeds to step 1560 where the process ends. If the outcome has a base monetary award less than the pre-determined non-zero threshold, the method proceeds to step 1535 where the rounding event is triggered by the game-logic circuitry. The rounding event provides an opportunity to increase the base monetary award. Next, at step 1540, in response to the earlier received second input and the triggering of the rounding event, play of a gamble feature of the rounding event is initiated by the game-logic circuitry. Then, at step 1545, an outcome of the gamble feature is determined by the determine game-logic circuitry. At step 1550, a determination is made if the outcome of the gamble feature is a winning outcome. If it is not, the method proceeds to step 1560 and ends. If the outcome of the gamble feature is a winning outcome, the method proceeds to step 1555 and a final award having an expected value that is greater than or equal to the predetermined non-zero threshold is awarded by the game-logic circuitry.

FIGS. 13-15, described by way of example above, include some aspects of algorithms that correspond to at least some instructions stored and executed by the game-logic circuitry 28 in FIG. 2 to perform the above described functions associated with the disclosed concepts.

In some aspects, a secondary or external system (see, e.g., FIG. 2) is associated with the gaming system, or may be a part of the gaming system, that temporarily intercepts the wagering game embodiment(s) described above and implements the described rounding event. For example, a gaming system determines the outcome of a wagering game and then, in response to a base monetary award for the outcome exceeding a predetermined non-zero threshold, the rounding event is triggered on the secondary system or the external system (e.g., whether a part of or associated with the gaming system). The rounding event that is implemented provides an opportunity to increase the base monetary award. The system can send an instruction to display on the display device an offer to gamble a monetary amount that is at least the difference between the base monetary award and the predetermined non-zero threshold. The system can then receive a second input indicative of, or an associated signal or value indicating, an acceptance of the offer to gamble. In response to receiving the second input, play of a gamble feature of the rounding event is initiated and an outcome of the gamble feature is determined. The system can then provide instructions, or an indication, to award a final award that is greater than the base monetary award in response to achieving a winning outcome in the gamble feature. Otherwise, the secondary or external system provides instructions, or an indication, to award a final award equal to the base monetary award minus the monetary amount of the offer to gamble such that the final award is less than or equal to the predetermined non-zero threshold in response to achieving a non-winning outcome in the gamble feature. Thereafter, the gaming system can then resume its previous operation as described in the previously described wagering game embodiment(s).

In another example of the secondary or external system, a gaming system determines the outcome of a wagering game and then, in response to a base monetary award for the outcome being less than a predetermined non-zero threshold that is the function of an initial wager, the rounding event is triggered that provides an opportunity to increase a base monetary award. The secondary or external system can send an instruction to display on a display device an offer to gamble the base monetary award. The system can then receive a second input indicative of, or an associated signal or value indicating, an acceptance of the offer to gamble. In response to receiving the second input, play of the gamble feature of the rounding event is initiated and an outcome is determined. In response to achieving a winning outcome in the gamble feature, a final award is awarded having an expected value that is greater than or equal to the predetermined non-zero threshold. Thereafter, the gaming system can then resume its previous operation as described in the previously described wagering game embodiment(s).

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
one or more input devices;
a display device;
game-logic circuitry, comprising one or more central processing units and one or more memory devices, the one or more memory devices storing instructions that, when executed by the one or more central processing units, cause the game-logic circuitry to:
receive, via at least one of the one or more input devices, a first input indicative of a first wager amount to play a wagering game;
determine an outcome of the wagering game;
in response to a base monetary award for the outcome exceeding a predetermined non-zero threshold, trigger a rounding event that provides an opportunity to increase the base monetary award;
display, on the display device, an offer to gamble a monetary amount that is at least the difference between the base monetary award and the predetermined non-zero threshold;
receive, via at least one of the one or more input devices, a second input indicative of an acceptance of the offer to gamble;
in response to receiving the second input, initiate play of a gamble feature of the rounding event;
determine an outcome of the gamble feature;
in response to achieving a winning outcome in the gamble feature, awarding a final award that is greater than the base monetary award; and
in response to achieving a non-winning outcome in the gamble feature, awarding a final award equal to the base monetary award minus the monetary amount of the offer to gamble such that the final award is less than or equal to the predetermined non-zero threshold.

2. The gaming system of claim 1, wherein the gamble feature uses true odds to determine the outcome of the gamble feature.

3. The gaming system of claim 2, wherein the rounding event includes a dice roll game, a card game, a reel spin game, a picking game, or any combination thereof.

4. The gaming system of claim 1, wherein the final award is at least 25 percent greater than the base monetary award.

5. The gaming system of claim 1, wherein the predetermined non-zero threshold is based on a government-determined threshold amount.

6. The gaming system of claim 5, wherein the government-determined threshold amount is an award amount that, when exceeded, requires further play of the wagering game to be temporarily suspended.

7. The gaming system of claim 1, wherein the rounding event includes an option for a non-random player selection of the increase to the base monetary award to be received for a winning outcome in the gamble feature.

8. The gaming system of claim 1, wherein the predetermined non-zero threshold is defined according to non-random player-selectable threshold options.

9. A gaming system comprising:
one or more input devices;
a display device;
game-logic circuitry, comprising one or more central processing units and one or more memory devices, the one or more memory devices storing instructions that, when executed by the one or more central processing units, cause the game-logic circuitry to:
receive, via at least one of the one or more input devices, a first input indicative of an initial wager to play a wagering game;
determine an outcome of the wagering game;
in response to a base monetary award for the outcome being less than a predetermined non-zero threshold that is a function of the initial wager, trigger a rounding event that provides an opportunity to increase the base monetary award;
display, on the display device, an offer to gamble the base monetary award;
receive, via at least one of the one or more input devices, a second input indicative of an acceptance of the offer to gamble;
in response to receiving the second input, initiate play of a gamble feature of the rounding event;
determine an outcome of the gamble feature; and
in response to achieving a winning outcome in the gamble feature, awarding a final award having an expected value that is greater than or equal to the predetermined non-zero threshold.

10. The gaming system of claim 9, wherein displaying the offer to gamble the base monetary award and the receiving a second input indicative of an acceptance occur before determining an outcome of the wagering game.

11. The gaming system of claim 9, wherein the final award is a credit amount.

12. The gaming system of claim 9, wherein the final award includes a game play feature.

13. The gaming system of claim 12, wherein the game play feature is a number of free spins having the expected value greater than or equal to the predetermined non-zero threshold.

14. The gaming system of claim 9, wherein the instructions further cause the game-logic circuitry to decrease the base monetary award to zero in response to the achieving a non-winning outcome in the gamble feature.

15. The gaming system of claim 9, wherein the gamble feature uses true odds to determine the outcome of the gamble feature.

16. The gaming system of claim 9, wherein the gamble feature is a dice roll game, a card game, a reel spin game, a picking game, or any combination thereof.

17. The gaming system of claim 9, wherein the rounding event includes an option for a non-random player selection of the final award to be received for achieving a winning outcome in the gamble feature.

18. The gaming system of claim 9, wherein the rounding event includes an option for a non-random player selection of the predetermined non-zero threshold that triggers the rounding event.

19. The gaming system of claim 9, wherein the final award is a whole-number multiple of the base monetary award.

20. The gaming system of claim 9, wherein the predetermined non-zero threshold is a whole-number multiple of the base monetary award.

21. The gaming system of claim 9, wherein the predetermined non-zero threshold is less than the base monetary award.

22. A computer-implemented method in a gaming system having game-logic circuitry including one or more central processing units and one or more memory devices, the method comprising:
receive, via one or more input devices, a first input indicative of a first wager amount to play a wagering game;
determine, by the game-logic circuitry, an outcome of the wagering game;
in response to a base monetary award for the outcome exceeding a predetermined non-zero threshold, trigger, by the game-logic circuitry, a rounding event that provides an opportunity to increase the base monetary award;
display on one or more display devices an offer to gamble a monetary amount that is at least the difference between the base monetary award and the predetermined non-zero threshold;
receive, via at least one of the one or more input devices, a second input indicative of an acceptance of the offer to gamble;
in response to receiving the second input, initiate, by the game-logic circuitry, play of a gamble feature of the rounding event;
determine, by the game-logic circuitry, an outcome of the gamble feature;
in response to achieving a winning outcome in the gamble feature, awarding, by the game-logic circuitry, a final award that is greater than the base monetary award; and
in response to achieving a non-winning outcome in the gamble feature, awarding, by the game-logic circuitry, a final award equal to the base monetary award minus the monetary amount of the offer to gamble such that the final award is less than or equal to the predetermined non-zero threshold.

23. A computer-implemented method in a gaming system having game-logic circuitry including one or more central processing units and one or more memory devices, the method comprising:
receive, via an input device, a first input indicative of an initial wager to play a wagering game;
display on a display device an offer to gamble in a rounding event base monetary awards for any outcomes less than a predetermined non-zero threshold that is a function of the initial wager, the rounding event providing an opportunity to increase the base monetary awards;
receive, via the input device, a second input indicative of an acceptance of the offer to gamble in the rounding event;
determine, by the game-logic circuitry, an outcome of the wagering game;
in response to a base monetary award for the outcome being less than the predetermined non-zero threshold, trigger, by the game-logic circuitry, the rounding event;
in response to receiving the second input, initiate, by the game-logic circuitry, play of a gamble feature of the rounding event;
determine, by the game-logic circuitry, an outcome of the gamble feature; and
in response to achieving a winning outcome in the gamble feature, awarding, by the game-logic circuitry, a final award having an expected value that is greater than or equal to the predetermined non-zero threshold.

24. The computer-implemented method of claim 23, wherein the rounding event includes an option for a non-random player selection of the final award to be received for achieving a winning outcome in the gamble feature.

25. The computer-implemented method of claim 23, wherein the rounding event includes an option for a non-random player selection of the predetermined non-zero threshold that triggers the rounding event.
